(19) United States
(12) Patent Application Publication
(10) Pub. No.: US 2002/0159138 A1
(43) Pub. Date: Oct. 31, 2002

(54) Access device for pump source in cascade erbium-doped fiber amplification

(76) Inventor: Meiyu Zou, Shenzhen (CN)

Correspondence Address: MERCHANT & GOULD PC, P.O. BOX 2903, MINNEAPOLIS, MN, 55402-0903, US

(21) Appl. No.: 09/845,671

(22) Filed: Apr. 30, 2001

(51) Int. Cl. H01S 3/00

(52) U.S. Cl. 359/341.32

(57) ABSTRACT

An access device for pump source in Erbium-doped fiber amplification is disclosed into the open by the present invention. The device comprises at least two pump sources. Before accessing to the wavelength division multiplexers of the Erbium-doped fiber amplifier, the pump sources are coupled by the couplers, the power of the output light of each pump source is reassigned at the output ports of the couplers. In this manner, all of the pump sources are constructed as an entity, the gain of the entire or plurality of the segments of the Erbium-doped fiber will be affected according to a fixed ratio when adjusting the power of one of the pump sources, therefore the bad influence to the smoothness of the output gain spectrum will not be occurred, or will be decreased, and the difficulty of controlling the smoothness of the gain can be decreased.

### FIELD OF THE INVENTION

The present invention relates to the field of telecommunication, more particularly, it relates to an access device for pump source in cascade Erbium-doped fiber amplification.

### BACKGROUND OF THE INVENTION

In the long distance optical fiber communication, after transmitting the optical signal for a specific distance, a repeater will be used to amplify the degraded optical signal for transmitting continuously from then on. The degraded optical signal will be converted to an electrical signal firstly by the conventional repeater, then after shaping and amplifying the electrical signal, the electrical signal will be converted again to a strong optical signal for transmitting. The repeater equipment is complicated and with bad reliability, and it is difficult to perform long distance under sea optical fiber communication. If an optical amplifier is used to amplify the optical signal directly, then the optics-electricity-optics conversion can be omitted, and the repeater may be simplified. An Erbium-doped fiber amplifier (hereinafter, referred to as EDFA) is one kind of the optical amplifiers, and a pump source is needed for exciting the Erbium-doped fiber, thereby the object of amplification is achieved. A specific structure of the Erbium-doped fiber amplifier is shown in FIG. 1. It is shown that the signal light is amplified only by a segment of the Erbium-doped fiber. If it is necessary to produce a high power EDFA, then the cascade amplification with multi-pump and multi-segment Erbium-doped fiber must be used. When the cascade amplification with multi-pump and multi-segment the Erbium-doped fiber is used for the existing high power EDFA, a separate pump source can be used by each segment of the Erbium-doped fiber, the structure of which is shown in FIG. 2. Only the structure of the amplification portion of the Erbium-doped fiber is shown in FIG. 2. After passing through the optical isolator 5, the signal light will be amplified by the Erbium-doped fibers 603, 703, 903, and 113 in turn, and finally, it is output by the optical isolator 12. Each of the wavelength division multiplexers (WDM) 601, 701, 901, and 111 is placed respectively in front of each segment of the Erbium-doped fibers 603, 703, 903, and 113; the pump light from pump lasers 602, 702, 902, and 112 and the signal light are multiplexed by the wavelength division multiplexers 601, 701, 901, and 111 respectively, and then it is output to the corresponding Erbium-doped fiber, thereby the amplification of the signal light can be realized. An optical isolator 8 is also placed in front of the wavelength division multiplexer 901, the function of which is to prevent the reverse exciting emission light from damaging the pump lasers 602, and 702; as well as from absorbing the reverse particle quantity of the Erbium-doped fibers 603, and 703 and decreasing the gain.

Following the occurrence of the wavelength division multiplexing system, the requirements of such as gain smoothing and gain controlling are put to the EDFA, and it is found that the gain spectrum of EDFA is associated directly with the reverse particle quantity of an Erbium-doped fiber through researching. But currently, the object of the gain control is reached mainly by changing the pump power. For a single power source, only one pump source will be controlled; but when there is a need of several pump sources for high output power, that only one pump source can be controlled will be a problem. In such cascade structure, by changing one of the pump sources only, the reverse particle quantity of one of the segments of the Erbium-doped fiber may be changed, but that of the remaining segments are not changed, so that the output spectrum which is overlapped by each of the segments will be uncertain, therefore it is rather difficult to control the gain smoothly. Of course, it is possible to change four pump sources simultaneously, but this will bring to a lot of control problem, for example, such as which pump source should be changed; and how much power should be changed for each pump source to allow maintaining the gain curve unchanged while controlling the gain.

### SUMMARY OF THE INVENTION

The object of the present invention is to provide an access device for pump source for a cascade EDFA. When this device is used for performing the gain control, the object of controlling the gain by changing less pump sources can be easily reached, in the meantime, the shape of the gain curve may not be affected.

The object of the present invention can be realized as follows. There are at least two pump lasers included in the access device for pump source in cascade Erbium-doped fiber amplification. The outputs from the pump lasers are multiplexed with the signal light by the wavelength division multiplexers before the access to the Erbium-doped fiber. The couplers are also included in the access device for pump source. The pump light outputs from the pump laser are coupled by the couplers at first, then it will be input to the wavelength division multiplexers.

The coupler is a 2×2 coupler, the output power ratio of it is 1:1; when the quantity of the segments of the cascade Erbium-doped fiber is N (N≧2), the quantity of the pump lasers which serve as pump sources is N, and the quantity of the 2×2 couplers is N−1.

Because the intercoupling is performed before connecting the pump sources to the Erbium-doped fibers, the plurality of the pump sources can be constructed as an entity rather than separately with each other. By adjusting the power of one of the pump sources, the gain of the entire of, or the plurality of the segments of the Erbium-doped fiber will be affected according to a fixed ratio; therefore the bad influence to the smoothness of the output gain spectrum will not be occurred, or will be decreased, and the difficulty of controlling the smoothness of the gain can be decreased while carrying out the gain control.

### BRIEF DESCRIPTION OF THE DRAWINGS

The present invention will be further described in conjunction with the embodiments and the drawings as follows.

FIG. 1 is a principle view of the Erbium-doped fiber amplification;

FIG. 2 is a view of the access structure for pump source in Erbium-doped fiber amplification in prior art;

FIG. 3 is a view of the access structure for pump source of an embodiment of the present invention;

FIG. 4 is a view of the access structure for pump source of another embodiment of the present invention.

### DETAILED DESCRIPTION OF THE PREFERRED EMBODIMENTS

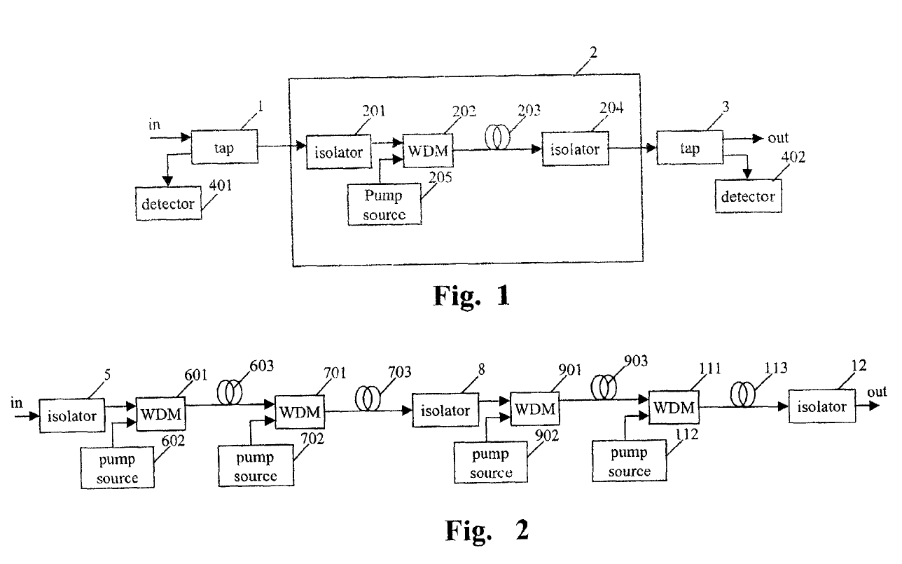

The principle of amplifying the signal light by the Erbium-doped fiber amplification is shown in FIG. 1. Passing through a tap 1, a small portion of the signal light may be separated and sent to a detector 401 used for monitoring the input signal light; and the majority of the light will be input to an optical isolator 201 of the Erbium-doped fiber amplifier 2 after passing through the tap 1, and input with the pump light output from the pump source individually to two ports of the wavelength division multiplexers (hereinafter, referred to as WDM) 202, after multiplexing, it will be output from the signal light port of WDM 202 and accessed to the Erbium-doped fiber for amplifying; and the light after amplifying will be passed through the optical isolator 204 again and input into the optical tap 3; and a small portion of the light may be separated and sent to the optical detector 402 for optical monitoring, and most of the light will be output as the signal light. Wherein, the optical tap 1 and the optical tap 3 can be used to output the signal light to the different ports according to the specific ratio; and the optical isolator 201, and 204 can be used to prevent the reflection light from oscillating to-and-fro in the optical path.

As mentioned above, FIG. 2 is a view of access structure for pump source in prior art.

In the present invention, the access device for pump source in cascade Erbium-doped fiber amplifying includes at least two pump lasers, and also includes the couplers; the pump light output from the pump lasers will be by the couplers at first, and then it will be output to the wavelength division multiplexers for multiplexing with the signal light.

An embodiment of the present invention is shown as FIG. 3. Four segments of the Erbium-doped fiber 142, 152, 172, and 182 are cascaded to implement the Erbium-doped fiber amplifying of the present embodiment, wherein each segment of the Erbium-doped fiber involves a WDM. After passing through the optical isolator 13, the signal light will be multiplexed with the pump light output from the first output port Out 1 of the pump source device 21 at the first WDM 141, then it will be output to the first segment of the Erbium-doped fiber 142 for amplifying the first time. Because the amplification coefficient of each segment is limited, the signal light after the first amplification will be input to the second WDM 151, where it may be multiplexed with the pump light output from the second output port Out 2 of the pump source device 21 for high power signal output; and then it will be amplified the second time at the second segment of the Erbium-doped fiber 152. As performed in the amplifications of the first time and the second time, the signal light after amplifying the second time will go through the third WDM 171 the third segment of the Erbium-doped fiber 172, the fourth WDM 181, and the fourth segment of the Erbium-doped fiber 182 in turn, for multiplexing with the pump light output from the third and the fourth output ports Out 3, and Out 4 of the pump source device 21 respectively and for amplifying; then it will be output to an external optical path via the optical isolator 19 for transmission or other usage. Wherein the isolator 16 is also used to prevent the reverse exciting emission light from affecting the amplification gain.

According to FIG. 3, there are four pump lasers (LD) 214, 215, 216, and 217, and three 2×2 couplers 211, 212, and 213 are included in a pair of the pump source devices of the present embodiment. The pump light outputs from the pump lasers 215 and 216 are input to two input ports of the couplet 213. The strength of the input pump light will be reassigned by the coupler 213 at two output ports, the output strength ratio of three couplers in the present embodiment is 1:1. Two output ports of the coupler 213 are connected to the input ports of the couplers 211, and 212 respectively, and are coupled to the pump light outputs from pump lasers 214, and 213 respectively. The pump light outputs from the pump laser 214 and the coupler 213 are coupled by the coupler 211, and then output evenly to two output ports, i.e., two output ports Out 1, and Out 2 of the pump source device 21. The pump light outputs from the pump laser 214 and the coupler 213 are coupled by the coupler 212, and then also output evenly from other two output ports of the pump source device.

By using the pump source device as shown in FIG. 3, when adjusting the amplification gain, only the output power of the pump lasers 215, or 216 will be required to be changed, at this time, the output power of four output ports Out 1, Out 2, Out 3 and Out 4 of the pump source device, as well as the gain of four segments of the Erbium-doped fiber, are changed synchronously, therefore the shape of the gain curve of the entire the Erbium-doped fiber amplifying will not be affected

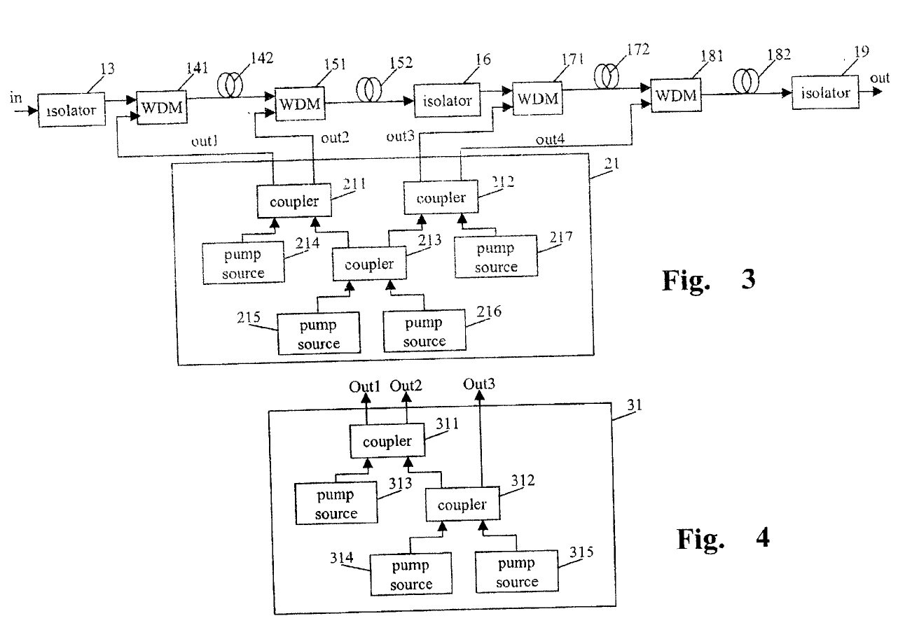

The cascade amplification is described for a four-segment Erbium-doped fiber in this embodiment. The access device for pump source is constructed by using four pump lasers coupled by three couplers, and the output power ratio of each coupler has the same value of 1:1. But the scope of the present invention is not limited by this, the pump source can be modified as required. For example, for a cascade amplification of three-segment Erbium-doped fiber, the pump source device 31 shown in FIG. 4 may be used. This device includes three pump lasers 313, 314, and 315, and two couplers 311 and 312, the pump light outputs from its three output ports Out 1, Out 2, and Out 3 may be used as the pump source of three segments of the Erbium-doped fiber. Furthermore, the output power ratio of the coupler is not limited at 1:1, other ratio may be used as required, for example, 1:2.

What is claimed is:

1. An access device for pump source in cascade Erbium-doped fiber amplification comprises at least two pump lasers, and the pump light outputs from them are multiplexed with the signal light by the wavelength division multiplexers before they access to the Erbium-doped fiber, wherein, the couplers are also included in the access device for pump source, and the pump light outputs from said pump laser are coupled by the couplers at first, then it is input to the wavelength division multiplexes.

2. The access device for pump source in cascade Erbium-doped fiber amplification according to claim 1, wherein, said coupler is a 2×2 coupler, and the output power ratio of is is 1:1; when the quantity of the segments of the Erbium-doped fiber is N (N≧2), the quantity of the pump lasers used as the pump source is N, and the quantity of said 2×2 coupler is N−1.

3. The access device for pump source in cascade Erbium-doped fiber amplification according to claim 1, wherein, said cascade Erbium-doped fiber is constructed by cascading total four segments of the Erbium-doped fiber (142), (152), (172), and (182); and four pump lasers (214), (215), (216), and (217), and three couplers (211), (212), and (213) are included in said access device for pump source, wherein the pump light output from the pump lasers (215), and (216) are coupled at the coupler (213), and its two output ports are coupled with the pump laser (214) and the pump laser (217) at the coupler (211) and the coupler (212) after the pump light being assigned evenly by the coupler (213), and the output ports of the couplers (211) and (212) are the output ports (Out 1, Out 2, Out 3, and Out 4) of the access device for pump source.

4. The access device for pump source in cascade Erbium-doped fiber amplification according to claim 1, wherein, said cascade Erbium-doped fiber is constructed by cascading three segments of the Erbium-doped fiber, and three pump lasers (313), (314), and (31), and two couplers (311), and (312) are included in said access device for pump source.
